(19) United States
(12) Patent Application Publication
(10) Pub. No.: US 2019/0164122 A1
(43) Pub. Date: May 30, 2019

(54) A Password-Sending-And-Receiving Device for Unmanned Aerial Vehicle for Logistics Delivery and Distribution

(71) Applicant: Beijing University of Technology, Beijing (CN)

(72) Inventors: Wenli Zhang, Beijing (CN); Weisheng Jia, Beijing (CN); Yingxuan Ma, Beijing (CN); Xiao Yan, Beijing (CN); Yiming Liu, Beijing (CN); Gang Song, Beijing (US); Xi Yang, Beijing (US)

(21) Appl. No.: 16/300,563

(22) PCT Filed: Apr. 13, 2017
(86) PCT No.: PCT/CN2017/080329

§ 371 Date: Nov. 10, 2018

(30) Foreign Application Priority Data
Nov. 9, 2016 (CN) CN201610986008.9

(51) Int. Cl. G06Q 10/08; H04B 10/116; H04L 9/08; B64C 39/02

(52) U.S. Cl. CPC G06Q 10/0833; H04B 10/116; B64C 2201/127; B64C 39/024; B64C 2201/128; H04L 9/0827

(57) ABSTRACT

The invention disclosed a password-sending-and-receiving device for logistics delivery and distribution by unmanned aerial vehicle (UAV), the technical scheme being the password-sending-and-receiving device. The device comes in two forms, the first form being the receiving end directly carries the authentication information for authentication, and the second form being that the receiving end obtains the authentication information through the network. In the first form, a password-sending-and-receiving device comprises three components: a Transmitter (10), an Authentication Service Information Server (20) and a Receiver (30) containing a Memory Module (31). In the second form, a Second Authentication Information Receiving Module (35) replaces the Memory Module (31). The Second Authentication Information Receiving Module (35) is connected to an Authentication Module (33), and is a wireless receiving module through wireless or wired network and can be used to receive authentication information sent by an Authentication Information Sending Module (22).

### CROSS REFERENCE TO RELATED APPLICATION

This application is a national stage application of International application number PCT/CN2017/080329, filed Apr. 13, 2017, titled “A Password-Sending-And-Receiving Device for Unmanned Aerial Vehicle for Logistics Delivery and Distribution”, which claims the priority benefit of Chinese Patent Application No. 201610986008.9, filed on Nov. 9, 2016, which is hereby incorporated by reference in its entirety.

### TECHNICAL FIELD

This invention relates to a device and method for password sending and receiving, in particular, to an electronic device used for unmanned aerial vehicle (UAV) delivery and distribution, and the method for sending and receiving the password that is attached to the electronic device.

### BACKGROUND

With its booming development, the logistic industry not only becomes an important part of the service-oriented industries and supports economic development, but also becomes an indispensable part of people's lives and brings unprecedent convenience to people's lives. Today's logistics industry is developing in the direction of information, automation and intelligence. Unmanned aerial vehicle (UAV) and other equipment are beginning to appear in the logistics industry.

UAV is mainly used in the express delivery, distribution, and transportation of logistics industry. UAV express delivery means to send packages and arrive at the destinations automatically via unmanned aerial vehicle or low-altitude aircraft operated by radio-controlled devices and program-controlled devices. The advantage includes solving the distribution problem in remote areas, improving delivery and distribution efficiency, and reducing labor costs.

The workflow process of the current domestic UAV expression delivery is as the following: after a package-sender places a package in an express delivery cabinet, the package-sender sends receiving information to the dispatching center, the dispatching center selects the suitable UAV and the mission command and destination coordinates to the UAV, the UAV flies to the target after receiving the instructions, the express delivery cabinet guides the UAV to land and automatically loads and unloads the package, after the package Is flown and delivered to an express delivery cabinet at the destination, the express delivery cabinet at the destination sends a message to the intended recipient, and the recipient picks up the package at the designated delivery cabinet.

The Chinese Patent Publication No. CN 102622788A disclosed an express depositing and accessing system and a method for express mail delivery and mailing based on the system. This express depositing and accessing system ultimately requires depositing the package to be delivered an electronic storage counter through human-machine interaction, and requires the recipient to enter a verification code into the human-machine interaction device on the electronic storage counter before picking up the package.

These two methods cannot deliver the package directly to the recipient, and the recipient needs to go to the designated express delivery counter to pick up the package, as a result, it is not as convenient as delivering by a person.

Amazon's UAV express delivery can deliver packages directly to recipients; however, in the process of human-computer interaction between the recipient and the UAV, the recipient needs to print a QR code large enough for the UAV to identify, thus is still convenient for the recipient.

### SUMMARY

In order to solve the above technical problems described in the background, the invention discloses a password-sending-and-receiving method and device that allows a direct man-machine interaction between a user and an UAV.

In order to achieve the above purpose, the invention disclosed a password-sending-and-receiving device for logistics delivery and distribution by unmanned aerial vehicle (UAV). The device comes in two forms, the first form being the receiving end directly carries the authentication information for authentication, and the second form being that the receiving end obtains the authentication information through a network.

In the first form, the password-sending-and-receiving device comprises three components: a Transmitter (10), an Authentication Service Information Server (20) and a Receiver (30).

The Authentication Service Information Server (20) comprises an Authentication Information Generation Module (21), an Authentication Information Sending Module (22), wherein Authentication Information Generation Module (21) and Authentication Information Sending Module (22) are sequentially connected.

The Authentication Information Generation Module (21) is configured to, after receiving an express delivery order, randomly generate an authentication information in the form of binary number that starts with 1, ends with 1, contains appropriate digits, and ensures uniqueness of the authentication information, in some embodiments.

The Authentication Information Sending Module (22) is a signal-sending module via a wireless network or wired network and configured to send the authentication information generated by the Authentication Information Generation Module (21) via a wireless network or wired network, in some embodiments.

The Transmitter (10) comprises a First Authentication Information Receiving Module (11), an Encoder (12), and a Sending Module (13), wherein the First Authentication Information Receiving Module (11), the Encoder (12), and the Sending Module (13) are sequentially connected.

The First Authentication Information Receiving Module (11) is a signal-receiving module via a wireless network or wired network and configured to receive the authentication information sent from the Authentication Information Sending Module (22).

the Encoder (12) is used to process and transform the authentication information, by converting the authentication information into an electrical signal that controls the bright or dark state of LED light, and duration of the bright or dark state, in some embodiments.

The Sending Module (13) comprises a device capable of emitting light, such as a LED lamp, in some embodiments.

The Transmitter (10) is a mobile communication device fitted with a flashlight, such as a mobile phone, a smartphone, in some embodiments.

The Receiver (30) comprises a Memory Module (31), a Photo Module (32), an Authentication Module (33), and an Output Module (34); wherein the Photo Module (32), the Authentication Module (33), and the Output Module (34) are sequentially connected, and the Memory Module (31) and the Authentication Module (33) are connected, in some embodiments.

The Memory Module (31) comprises a memory storage unit with read function, such as a memory card, in some embodiments.

The Photo Module (32) is a device with photograph-taking or video-taking function, such as a camera installed within a smartphone, in some embodiments.

The Authentication Module (33) is configured to compare the information from the photograph or video taken by the Photo Module (32) with the stored information in the Memory Module (31) and arrive at a conclusion.

The Output Module (34) is a wireless transmission module, in some embodiments.

The Receiver (30) is implemented on an UAV fitted with a camera, in some embodiments.

The invention discloses a method for sending and receiving password, comprising the steps of: after receiving an express delivery information from a user, generating a unique, one-time-only authentication information by the Authentication Service Information Server (20); storing the authentication information in the Memory Module (31) of the Receiver (30); after receiving the authentication information generated by the Authentication Service Information Server (20), the Transmitter (10) used by a user converts the authentication information into the electrical signal that controls the bright or dark state of LED light and duration of the bright or dark state; sending, by the Sending Module (13), the converted authentication information in the form of LED light; after receiving the converted authentication information in the form of LED light by the Receiver (30) implemented on the UAV, the Receiver (30) converts the converted authentication information into a binary number information and compares the binary number information with the authentication information stored in the Memory Module (31); If the information agree with each other, the package is delivered to the user, meanwhile the one-time-only authentication information is destroyed; sending, by the Sending Module (13), a receipt indicating delivery of the package to the Authentication Service Information Server (20).

In the second form for the present invention, the Memory Module (31) is replaced by a Second Authentication Information Receiving Module (35, the Photo Module (32), the Authentication Module (33), and the Output Module (34) are sequentially connected, and the Second Authentication Information Receiving Module (35) and the Authentication Module (33) are connected. The Second Authentication Information Receiving Module (35) is module configured to receive wireless signals through wireless or wired network and to receive the authentication information sent from the Authentication Information Sending Module (22).

In the second form for the present invention, the password-sending-and-receiving device for logistics delivery and distribution by UAV is configured to send and receive password through the steps of: after receiving an express delivery information from a user, generating a unique, one-time-only authentication information by the Authentication Service Information Server (20); sending, from the Authentication Service Information Server (20), the authentication information through a wireless network to the First Authentication Information Receiving Module (11) in the Transmitter (10) and the Second Authentication Information Receiving Module (35) in the Receiver (30); after receiving the authentication information generated by the Authentication Service Information Server (20), the Transmitter (10) used by a user converts the authentication information into the electrical signal that controls the bright or dark state of LED light and duration of the bright or dark state; sending, by the Sending Module (13), the converted authentication information in the form of LED light; after receiving the converted authentication information in the form of LED light by the Receiver (30) implemented on the UAV, the Receiver (30) converts the converted authentication information into a binary number information and compares the binary number information with the authentication information stored in the Memory Module (31); If the information agree with each other, the package is delivered to the user, meanwhile the one-time-only authentication information is destroyed; sending, by the Sending Module (13), a receipt indicating delivery of the package to the Authentication Service Information Server (20).

### BRIEF DESCRIPTION OF THE DRAWINGS

FIG. 1 is a schematic diagram of the password-sending-and-receiving device in form 1, according to some embodiments. 10: Transmitter; 11: First Authentication Information Receiving Module; 12: Encoders; 13: Sending Modules; 20: Authentication Service Information Server; 21: Authentication Information Generation Module; 22: Authentication Information Sending Module; 30: Receiver; 31: Memory Module; 32: Photo Module; 33: Authentication Module; 34: Output Module.

FIG. 2 is a schematic diagram of the password-sending-and-receiving device in form 2, according to some embodiments. 10: Transmitter; 11: First Authentication Information Receiving Module; 12: Encoders; 13: Sending Modules; 20: Authentication Service Information Server; 21: Authentication Information Generation Module; 22: Authentication Information Sending Module; 30: Receiver; 31: Memory Module; 32: Photo Module; 33: Authentication Module; 35: Second Authentication Information Receiving Module.

FIG. 3 is a schematic diagram showing a binary processing of the image collected by the receiving end of the device.

FIG. 4 is a schematic diagram of partitioning image after the binary processing.

FIG. 5 shows the information 1 collected by the receiving end of the device.

FIG. 6 shows the information 0 collected by the receiving end of the device.

FIG. 7 is a schematic representation of the authentication process when the authentication information is 101010101.

### DETAILED DESCRIPTION OF THE PREFERRED EMBODIMENTS

The preferred embodiments are described herein in four cases. Other schemes and configures are possible.

### Embodiment 1

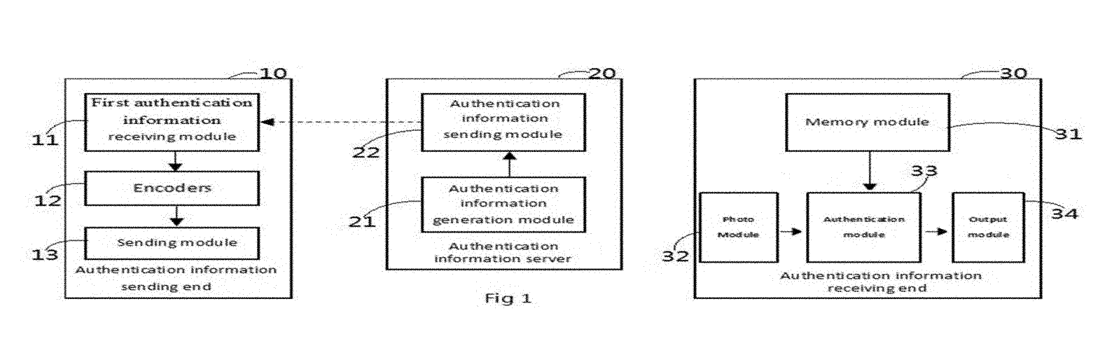

FIG. 1 shows the device and method wherein the receiving end directly carries the authentication information for authentication. The device disclosed in the invention comprises three components: the Transmitter (10), the Authentication Service Information Server (20), and the Receiver (30), wherein, the Transmitter (10) can be a cell phone or smartphone with a flashlight or other programmable electronic device with a flashlight. The Transmitter (10) includes the First Authentication Information Receiving Module (11), the Encoders (12), and the Sending Module (13).

The Authentication Service Information Server (20) can be a general server commonly used by various entities. The Authentication Service Information Server (20) includes the Authentication Information Generation Module (21) and the Authentication Information Sending Module (22). The Authentication Information Sending Module (22) can send an authentication information through a network to the First Authentication Information Receiving Module (11) of the Transmitter (10) and to the Receiver (30). After coding by the Encoders (12), the authentication information can control the number of brightness and darkness and the duration of the brightness and darkness of the Sending Module (13) in the Transmitter (10).

The Receiver (30) can be an electronic device with a photo sensor or a camera, such as a UAV with a camera, in some embodiments. The Receiver (30) includes the Memory Module (31), the Photo Module (32), the Authentication Module (33), and the Output Module (34).

The workflow of the devices is as follows:

After the Authentication Service Information Server (20) receives a user's express delivery information, the Authentication Information Generation Module (21) randomly generates an authentication information in the form of a binary number that starts with 1 and ends with 1, which is inducible to determining the beginning and end of the authentication information, wherein the binary number also contains appropriate digits and ensures uniqueness of the authentication information. The Memory Module (31) of the Receiver (30) stores this authentication information beforehand. For example, prior to the taking off of the UAV. Meanwhile, the Authentication Information Sending Module (22) in the Authentication Service Information Server (20) sends this authentication information over a wireless network to the First Authentication Information Receiving Module (11) in the Transmitter (10). After the First Authentication Information Receiving Module (11) received the authentication information, The Encoders (12) encodes the authentication information of the binary number and transforms it into the electrical signal controlling the Sending Module (13), to control the number of darkness and brightness of the flashlights in the Sending Module (13) and the duration of the darkness and brightness. The Sending Module (13) emits Morse code or the binary authentication information as marked and demonstrated by light and darkness, which is used to authenticate information with the Receiver (30).

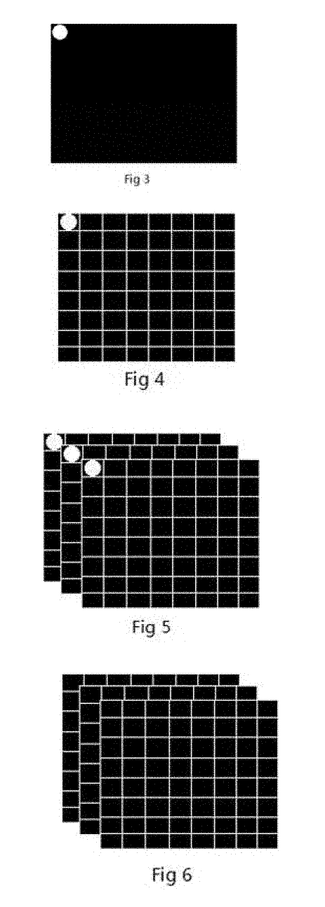

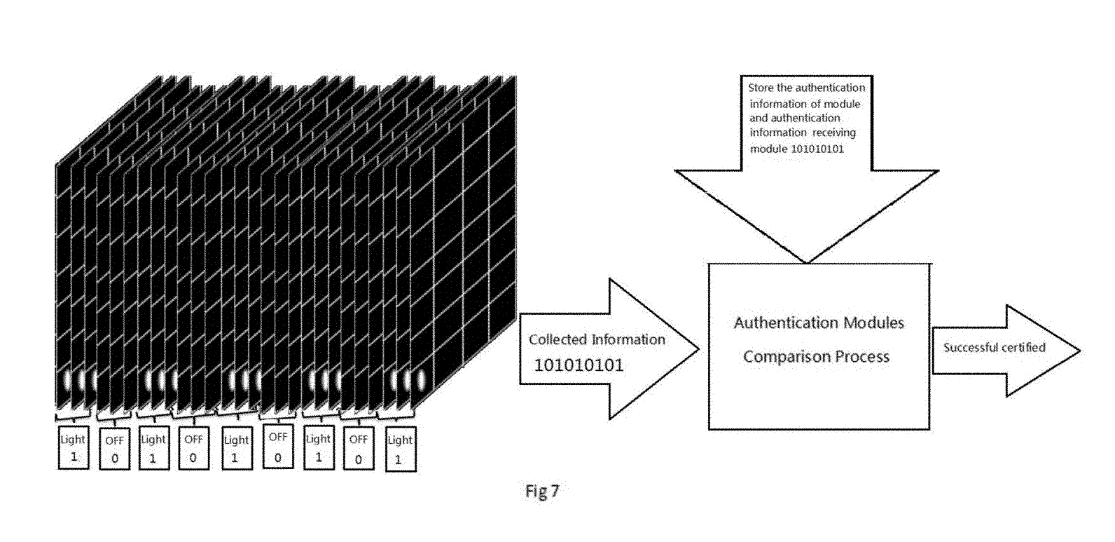

The Photo Module (32) in the Receiver (30) performs a binary treatment on the image after collecting an image, the result of the treatment only reflecting the highly bright part of the image, as shown FIG. 3. the Authentication Module (33) divides the binary image into N*M areas, as shown in FIG. 4. The brightness and darkness of the lamp usually occupy several frames, for example FIG. 5 shows the detection of light (the lamp is on) corresponding to 1 in the authentication information, also for example FIG. 6 shows the detection of darkness (the lamp is turn off) corresponding to 0 in the authentication information. The binary information of each region is compared with the binary authentication information stored in the Memory Module (31). If successfully matched, the Output Module (34) will output a successful authentication signal to guide the UAV to deliver the package, otherwise the Output Module (34) will output an authentication failure signal and waits for other operations. FIG. 7 shows the authentication process when the authentication information is 101010101.

This process allows the user to use a cellphone at home to directly perform information authentication with a delivery UAV and to get the package.

### Embodiment 2

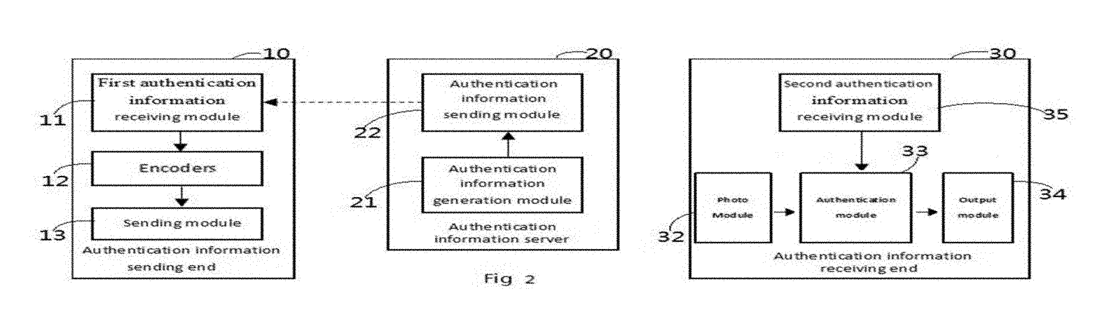

FIG. 2 shows the device and method wherein the receiving end obtains the authentication information through a network in order to authenticate. The device disclosed by the invention includes three components: the Transmitter (10), the Authentication Service Information Server (20), and the Receiver (30). Wherein, the Transmitter (10) can be a cell phone with a flashlight or other programmable electronic device with a flashlight, in some embodiments. The Transmitter (10) includes the First Authentication Information Receiving Module (11), the Encoders (12) and the Sending Module (13).

The Authentication Service Information Server (20) can be a general server commonly used by various entities. The Authentication Service Information Server (20) includes the Authentication Information Generation Module (21) and the Authentication Information Sending Module (22). The Authentication Information Sending Module (22) can send an authentication information through a network to the First Authentication Information Receiving Module (11) of the Transmitter (10) and to the Second Authentication Information Receiving Module (35) of the Receiver (30). After coding by the Encoders (12), the authentication information can control the number of brightness and darkness and the duration of the brightness and darkness of the Sending Module (13) in the Transmitter (10).

The Receiver (30) can be an electronic device with a photo sensor or a camera, such as a UAV with a camera, in some embodiments. The Receiver (30) includes the Second Authentication Information Receiving Module (35), the Photo Module (32), the Authentication Module (33), and the Output Module (34)

The workflow of the devices is as follows:

After the Authentication Service Information Server (20) receives a user's express delivery information, the Authentication Information Generation Module (21) randomly generates an authentication information in the form of a binary number that starts with 1 and ends with 1, which is inducible to determining the beginning and end of the authentication information, wherein the binary number also contains appropriate digits and ensures uniqueness of the authentication information. Subsequently, the Authentication Information Sending Module (22) in the Authentication Service Information Server (20) sends a Morse code represented by 0 and 1 or a self-defined binary authentication information such as 101011101 over the wireless network to the First Authentication Information Receiving Module (11) in the Transmitter (10) and to the Second Authentication Information Receiving Module (35) in the Receiver (30). After the First Authentication Information Receiving Module (11) received the authentication information, the Encoders (12) will encode the binary authentication information and transform it into the electrical signal that controls the Sending Module (13), to control the number of darkness and brightness of the flashlight, and the duration of the darkness and brightness, of the Sending Module (13). the Sending Module (13) emits Morse code or the binary authentication information as marked and demonstrated by light and darkness, which is used to authenticate information with the Receiver (30).

The Photo Module (32) in the Receiver (30) performs a binary treatment on the image after collecting an image, the result of the treatment only reflecting the highly bright part of the image, as shown FIG. 3. the Authentication Module (33) divides the binary image into N*M areas, as shown in FIG. 4. The brightness and darkness of the lamp usually occupy several frames, for example FIG. 5 shows the detection of light (the lamp is on) corresponding to 1 in the authentication information, also for example FIG. 6 shows the detection of darkness (the lamp is turn off) corresponding to 0 in the authentication information. The binary information of each region is compared with the binary authentication information stored in the Memory Module (31). If successfully matched, the Output Module (34) will output a successful authentication signal to guide the UAV to deliver the package, otherwise the Output Module (34) will output an authentication failure signal and waits for other operations. FIG. 7 shows the authentication process when the authentication information is 101010101.

This process allows the user to use a cellphone at home to directly perform information authentication with a delivery UAV and to get the package.

### Embodiment 3

This method of sending and receiving passwords can also be applied to the human-machine interaction process between human and robot. As shown in FIG. 2, the device disclosed by the invention includes three components: the Transmitter (10), the Authentication Service Information Server (20) and the Receiver (30). Wherein, the Transmitter (10) can be a cell phone with a flashlight or other programmable electronic device with a flashlight. The Transmitter (10) includes the First Authentication Information Receiving Module (11), the Encoders (12) and the Sending Module (13).

The Authentication Service Information Server (20) can be a general server commonly used by various entities. The Authentication Service Information Server (20) includes the Authentication Information Generation Module (21) and the Authentication Information Sending Module (22). The Authentication Information Sending Module (22) can send an authentication information through a network to the First Authentication Information Receiving Module (11) of the Transmitter (10) and to the Second Authentication Information Receiving Module (35) of the Receiver (30). After coding by the Encoders (12), the authentication information can control the number of brightness and darkness and the duration of the brightness and darkness of the Sending Module (13) in the Transmitter (10).

The Receiver (30) can be a robot with a photo sensor or a camera, in some embodiments. The Receiver (30) includes the Second Authentication Information Receiving Module (35), the Photo Module (32), the Authentication Module (33), and the Output Module (34)

The workflow of the devices is as follows:

After the Authentication Service Information Server (20) receives a user's express delivery information, the Authentication Information Generation Module (21) randomly generates an authentication information in the form of a binary number that starts with 1 and ends with 1, which is inducible to determining the beginning and end of the authentication information, wherein the binary number also contains appropriate digits and ensures uniqueness of the authentication information. Subsequently, the Authentication Information Sending Module (22) in the Authentication Service Information Server (20) sends a Morse code represented by 0 and 1 or a self-defined binary authentication information such as 101011101 over the wireless network to the First Authentication Information Receiving Module (11) in the Transmitter (10) and to the Second Authentication Information Receiving Module (35) in the Receiver (30). After the First Authentication Information Receiving Module (11) received the authentication information, the Encoders (12) will encode the binary authentication information and transform it into the electrical signal that controls the Sending Module (13), to control the number of darkness and brightness of the flashlight, and the duration of the darkness and brightness, of the Sending Module (13). the Sending Module (13) emits Morse code or the binary authentication information as marked and demonstrated by light and darkness, which is used to authenticate information with the Receiver (30).

The Photo Module (32) in the Receiver (30) performs a binary treatment on the image after collecting an image, the result of the treatment only reflecting the highly bright part of the image, as shown FIG. 3. the Authentication Module (33) divides the binary image into N*M areas, as shown in FIG. 4. The brightness and darkness of the lamp usually occupy several frames, for example FIG. 5 shows the detection of light (the lamp is on) corresponding to 1 in the authentication information, also for example FIG. 6 shows the detection of darkness (the lamp is turn off) corresponding to 0 in the authentication information. The binary information of each region is compared with the binary authentication information stored in the Memory Module (31). If successfully matched, the Output Module (34) will output a successful authentication signal to guide the UAV to deliver the package, otherwise the Output Module (34) will output an authentication failure signal and waits for other operations. FIG. 7 shows the authentication process when the authentication information is 101010101.

### Embodiment 4

This method of sending and receiving password can also be applied in the communication process between UAV and UAV during formation flying or other tasks. As shown in FIG. 2, the device disclosed by the invention includes three components: the Transmitter (10), the Authentication Service Information Server (20) and the Receiver (30). Wherein, the Transmitter (10) can be a UAV with a flashlight. The Transmitter (10) includes the First Authentication Information Receiving Module (11), the Encoders (12) and the Sending Module (13).

The Authentication Service Information Server (20) can be a general server commonly used by various entities. The Authentication Service Information Server (20) includes the Authentication Information Sending Module (22). The Authentication Information Sending Module (22) can send an authentication information through a network to the First Authentication Information Receiving Module (11) of the Transmitter (10) and to the Second Authentication Information Receiving Module (35) of the Receiver (30). After coding by the Encoders (12), the authentication information can control the number of brightness and darkness and the duration of the brightness and darkness of the Sending Module (13) in the Transmitter (10).

The Receiver (30) can be a UAV with a photo sensor or a camera, in some embodiments. The Receiver (30) includes the Second Authentication Information Receiving Module (35), the Photo Module (32), the Authentication Module (33), and the Output Module (34).

The workflow of the devices is as follows:

After the Authentication Service Information Server (20) receives a user's express delivery information, the Authentication Information Generation Module (21) randomly generates an authentication information in the form of a binary number that starts with 1 and ends with 1, which is inducible to determining the beginning and end of the authentication information, wherein the binary number also contains appropriate digits and ensures uniqueness of the authentication information. Subsequently, the Authentication Information Sending Module (22) in the Authentication Service Information Server (20) sends a Morse code represented by 0 and 1 or a self-defined binary authentication information such as 101011101 over the wireless network to the First Authentication Information Receiving Module (11) in the Transmitter (10) and to the Second Authentication Information Receiving Module (35) in the Receiver (30). After the First Authentication Information Receiving Module (11) received the authentication information, the Encoders (12) will encode the binary authentication information and transform it into the electrical signal that controls the Sending Module (13), to control the number of darkness and brightness of the flashlight, and the duration of the darkness and brightness, of the Sending Module (13). the Sending Module (13) emits Morse code or the binary authentication information as marked and demonstrated by light and darkness, which is used to authenticate information with the Receiver (30).

The Photo Module (32) in the Receiver (30) performs a binary treatment on the image after collecting an image, the result of the treatment only reflecting the highly bright part of the image, as shown FIG. 3. the Authentication Module (33) divides the binary image into N*M areas, as shown in FIG. 4. The brightness and darkness of the lamp usually occupy several frames, for example FIG. 5 shows the detection of light (the lamp is on) corresponding to 1 in the authentication information, also for example FIG. 6 shows the detection of darkness (the lamp is turn off) corresponding to 0 in the authentication information. The binary information of each region is compared with the binary authentication information stored in the Memory Module (31). If successfully matched, the Output Module (34) will output a successful authentication signal to guide the UAV to deliver the package, otherwise the Output Module (34) will output an authentication failure signal and waits for other operations. FIG. 7 shows the authentication process when the authentication information is 101010101.

What is claimed is:

1. A password-sending-and-receiving device for logistics delivery and distribution by Unmanned Aerial Vehicle (UAV), comprising an Authentication Service Information Server (20), a Transmitter (10) sending a password, and a Receiver (30) receiving a password, wherein a receiving end of the device carries authentication information for authentication purpose;
the Authentication Service Information Server (20) comprises an Authentication Information Generation Module (21), an Authentication Information Sending Module (22), wherein Authentication Information Generation Module (21) and Authentication Information Sending Module (22) are sequentially connected;
the Authentication Information Generation Module (21) is configured to, after receiving an express delivery order, randomly generate an authentication information in the form of a binary number that starts with 1 and ends with 1, which is inducible to determining the beginning and the end of the authentication information, wherein the binary number also contains appropriate digits and ensures uniqueness of the authentication information;
the Authentication Information Sending Module (22) is a signal-sending module via a wireless network or wired network and configured to send the authentication information generated by the Authentication Information Generation Module (21) via a wireless network or wired network;
the Transmitter (10) comprises a First Authentication Information Receiving Module (11), an Encoder (12), and a Sending Module (13), wherein the First Authentication Information Receiving Module (11), the Encoder (12), and the Sending Module (13) are sequentially connected;
the First Authentication Information Receiving Module (11) is a signal-receiving module via a wireless network or wired network and configured to receive the authentication information sent from the Authentication Information Sending Module (22).
the Receiver (30) comprises a Memory Module (31), a Photo Module (32), an Authentication Module (33), and an Output Module (34); wherein the Photo Module (32), the Authentication Module (33), and the Output Module (34) are sequentially connected, and the Memory Module (31) and the Authentication Module (33) are connected; and
the Receiver (30) is implemented on an UAV fitted with a camera.

2. The password-sending-and-receiving device for logistics delivery and distribution by UAV according to claim 1, wherein the Encoder (12) is configured to process and transform the authentication information, by converting the authentication information into an electrical signal that controls the bright or dark state of LED light, and duration of the bright or dark state.

3. The password-sending-and-receiving device for logistics delivery and distribution by UAV according to claim 1, wherein the Sending Module (13) comprises a LED light capable of emitting light.

4. The password-sending-and-receiving device for logistics delivery and distribution by UAV according to claim 1, wherein the Transmitter (10) comprises a mobile communication device with a flashlight.

5. The password-sending-and-receiving device for logistics delivery and distribution by UAV according to claim 1, wherein the Memory Module (31) comprises a memory card with read function.

6. The password-sending-and-receiving device for logistics delivery and distribution by UAV according to claim 1, wherein the Photo Module (32) is a device with photograph-taking or video-taking function, the Authentication Module (33) is configured to compare the information from the photograph or video taken by the Photo Module (32) with the stored information in the Memory Module (31) and arrive at a conclusion, and the Output Module (34) is a wireless transmission module.

7. The password-sending-and-receiving device for logistics delivery and distribution by UAV according to claim 1, configured to send and receive password through the steps of: after receiving an express delivery information from a user, generating a unique, one-time-only authentication information by the Authentication Service Information Server (20); storing the authentication information in the Memory Module (31) of the Receiver (30); after receiving the authentication information generated by the Authentication Service Information Server (20), the Transmitter (10) used by a user converts the authentication information into the electrical signal that controls the bright or dark state of LED light and duration of the bright or dark state; sending, by the Sending Module (13), the converted authentication information in the form of LED light; after receiving the converted authentication information in the form of LED light by the Receiver (30) implemented on the UAV, the Receiver (30) converts the converted authentication information into a binary number information and compares the binary number information with the authentication information stored in the Memory Module (31); If the information agree with each other, the package is delivered to the user, meanwhile the one-time-only authentication information is destroyed; sending, by the Sending Module (13), a receipt indicating delivery of the package to the Authentication Service Information Server (20).

8. The password-sending-and-receiving device for logistics delivery and distribution by UAV according to claim 1, wherein a receiving end of the device receives the authentication information from a network, wherein the Memory Module (31) is replaced by a Second Authentication Information Receiving Module (35), wherein the Photo Module (32), the Authentication Module (33), and the Output Module (34) are sequentially connected, wherein the Second Authentication Information Receiving Module (35) and the Authentication Module (33) are connected; wherein the Second Authentication Information Receiving Module (35) is configured to receive wireless signals through wireless or wired network, and to receive the authentication information sent from the Authentication Information Sending Module (22).

9. The password-sending-and-receiving device for logistics delivery and distribution by UAV according to claim 8, configured to send and receive password through the steps of: after receiving an express delivery information from a user, generating a unique, one-time-only authentication information by the Authentication Service Information Server (20); sending, from the Authentication Service Information Server (20), the authentication information through a wireless network to the First Authentication Information Receiving Module (11) in the Transmitter (10) and the Second Authentication Information Receiving Module (35) in the Receiver (30); after receiving the authentication information generated by the Authentication Service Information Server (20), the Transmitter (10) used by a user converts the authentication information into the electrical signal that controls the bright or dark state of LED light and duration of the bright or dark state; sending, by the Sending Module (13), the converted authentication information in the form of LED light; after receiving the converted authentication information in the form of LED light by the Receiver (30) implemented on the UAV, the Receiver (30) converts the converted authentication information into a binary number information and compares the binary number information with the authentication information stored in the Memory Module (31); If the information agree with each other, the package is delivered to the user, meanwhile the one-time-only authentication information is destroyed; sending, by the Sending Module (13), a receipt indicating delivery of the package to the Authentication Service Information Server (20).
